(19) United States
(12) Patent Application Publication
(10) Pub. No.: US 2016/0381439 A1
(43) Pub. Date: Dec. 29, 2016

(54) INDOOR ENVIRONMENT MANAGEMENT APPARATUS, INDOOR ENVIRONMENT CONTROL SYSTEM, AND COMPUTER-READABLE RECORDING MEDIUM

(71) Applicants: Shinya SATOH, Tokyo (JP); Kojiro FURUYA, Tokyo (JP); Ruiko KIKKAWA, Tokyo (JP); Tatsuya ISHIKAWA, Tokyo (JP); Iyo KUDOH, Tokyo (JP); Naoya MOTOMURA, Tokyo (JP)

(72) Inventors: Shinya SATOH, Tokyo (JP); Kojiro FURUYA, Tokyo (JP); Ruiko KIKKAWA, Tokyo (JP); Tatsuya ISHIKAWA, Tokyo (JP); Iyo KUDOH, Tokyo (JP); Naoya MOTOMURA, Tokyo (JP)

(21) Appl. No.: 15/185,878

(22) Filed: Jun. 17, 2016

(30) Foreign Application Priority Data
Jun. 25, 2015 (JP) 2015-128065

(51) Int. Cl. H04Q 9/00; G05B 15/02

(52) U.S. Cl. CPC H04Q 9/00; G05B 15/02; H04Q 2213/002

(57) ABSTRACT

An indoor environment management apparatus includes a receiver, a display controller, an operation receiver, and a control unit. The receiver is configured to receive a measurement result from a measurement device that measures data concerning an indoor environment. The display controller is configured to display, in an operation terminal of a user, an indoor environment map in which the measurement result received by the receiver is displayed on a floor plan of an indoor space. The operation receiver is configured to receive a user operation with respect to a control device that adjusts the indoor environment from the operation terminal. The control unit is configured to generate control information by which the indoor environment is changed depending on the user operation, and output the generated control information to the control device.

### CROSS-REFERENCE TO RELATED APPLICATION

The present application claims priority under 35 U.S.C. §119 to Japanese Patent Application No. 2015-128065 filed Jun. 25, 2015. The contents of which are incorporated herein by reference in their entirety.

### BACKGROUND OF THE INVENTION

1. Field of the Invention

The present invention relates to an indoor environment management apparatus, an indoor environment control system, and a computer-readable recording medium.

2. Description of the Related Art

Conventionally, an air conditioning management system, a lighting management system, and the like in which an indoor environment such as air conditioning and lighting is appropriately adjusted depending on a presence/absence of a human figure in an office space and a living space have been known. In such an indoor environment control system, an output of a control device such as an air conditioner and lighting equipment is reduced in the space to reduce power consumption when there is no human figure or a few human figures.

For example, Japanese Laid-open Patent Publication No. 2006-125727 discloses a technique of changing a discharge amount of conditioned air of a system ceiling module or a luminance of lighting equipment depending on a detection result by a human figure detecting sensor. Besides, Japanese Laid-open Patent Publication No. 2014-078398 discloses a technique of identifying a location of a person who carries a smartphone based on positional information and a terminal ID of a smartphone and adjusting an output of an LED for lighting depending on the location of the person. Japanese Laid-open Patent Publication No. 2014-078398 also discloses a technique of a manual adjustment into a brightness desired by a user in addition to an execution of an automatic control of the lighting.

However, it is impossible in the conventional techniques to grasp actual conditions of indoor environment including a distribution of other persons in the space and distributions of temperature and luminance, and an output status of a control device such as an air conditioner and lighting equipment in one glance. Therefore, the existing situation is that a user who wants to manually adjust the air conditioning and the brightness has a difficulty in easily adjusting the temperature and turning on/off the lighting since it is difficult to grasp the conditions of other persons in the space.

### SUMMARY OF THE INVENTION

According to one aspect of the present invention, an indoor environment management apparatus includes a receiver, a display controller, an operation receiver, and a control unit. The receiver is configured to receive a measurement result from a measurement device that measures data concerning an indoor environment. The display controller is configured to display, in an operation terminal of a user, an indoor environment map in which the measurement result received by the receiver is displayed on a floor plan of an indoor space. The operation receiver is configured to receive a user operation with respect to a control device that adjusts the indoor environment from the operation terminal. The control unit is configured to generate control information by which the indoor environment is changed depending on the user operation, and output the generated control information to the control device.

### BRIEF DESCRIPTION OF THE DRAWINGS

FIG. 1 is a brief overview of a configuration of an indoor environment control system according to an embodiment;

FIG. 2 is a functional block diagram of a configuration of functions included in each of devices in the indoor environment control system;

FIG. 3 is an explanatory view of a data conversion processing by a data conversion module;

FIG. 4 is a perspective view explaining an installation example of a measurement device and a measurement area thereof;

FIG. 5 is a front view when the measurement device installed on the ceiling is seen from a position right under the device;

FIG. 6 illustrates a frame format of an example of a correspondence between a measurement area of the measurement device and an indoor area which is divided into zones;

FIG. 7 illustrates a frame format explaining a method of generating measurement data by the measurement device;

FIG. 8 is an explanatory view of a method of generating display data;

FIG. 9 illustrates an indoor environment map displayed in an operation terminal;

FIG. 10 is an explanatory view of an example of a method of automatically control lighting equipment;

FIG. 11 is an explanatory view of an example of setting a control target area;

FIG. 12 illustrates an example of a dimming control screen which is displayed in the operation terminal;

FIG. 13 is a sequence diagram illustrating an example of a procedure of a display data generation processing for measurement result, the processing being executed in the indoor environment control system; and

FIG. 14 is a sequence diagram illustrating an example of a procedure of a manual control processing executed in the indoor environment control system.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an indoor environment management apparatus, an indoor environment control system, and a computer-readable recording medium that enable a user to easily check indoor conditions such as a condition of an indoor environment and an output status of a control device when the user wants to adjust the indoor environment.

An exemplary embodiment of an indoor environment management apparatus, an indoor environment control system, and a program will be explained in detail below with reference to the accompanying drawings. It should be noted that the present invention is not limited to the embodiment to be explained below.

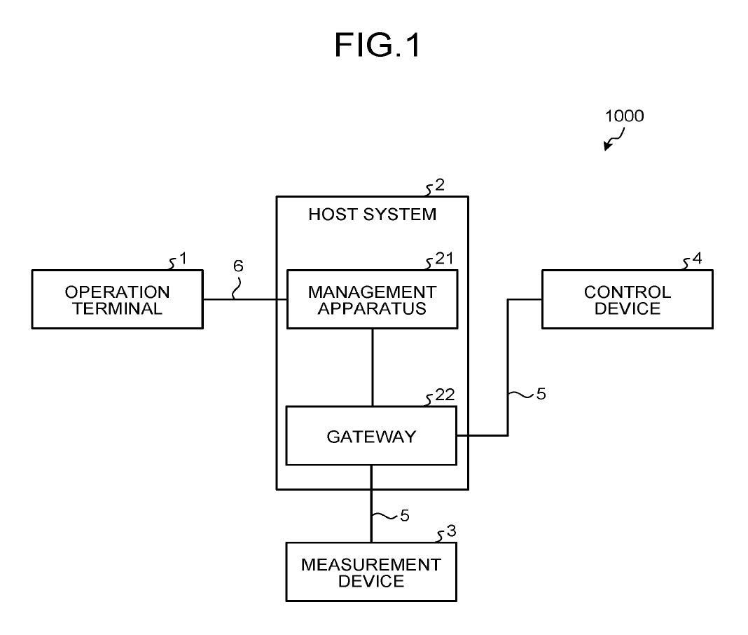

First, a brief overview of a configuration of an indoor environment control system 1000 according to an embodiment will be explained. FIG. 1 is a brief overview of a configuration of an indoor environment control system 1000 according to the embodiment. As illustrated in FIG. 1, the indoor environment control system 1000 is mainly provided with an operation terminal 1, a host system 2, a measurement device 3, and a control device 4. The host system 2 is provided with a management apparatus 21 (an indoor environment management apparatus) and a gateway 22, the management apparatus 21 being connected to the measurement device 3 or the control device 4 via the gateway 22 and a connection line 5. For the connection line 5, a wired LAN (Local Area Network), a wireless LAN, or the like may be used, for example. The management apparatus 21 and the operation terminal 1 are configured to be connected to each other via a connection line 6 using a wired LAN, a wireless LAN, or the like.

The operation terminal 1 is used by a user for monitoring and manually adjusting an indoor environment. For the operation terminal 1, a mobile terminal such as a tablet terminal, a PC, and a smartphone may be used, for example. The operation terminal 1 is provided with a touch sensitive panel on a front surface of a liquid crystal panel and receives operations via touching by the user. Here, the configuration of a user interface is not limited to the touch sensitive panel, operation buttons of various kinds or a microphone may be used, or a combination of the operation buttons and the microphone may be used.

The measurement device 3 includes a sensor that measures the indoor environment. In a system whose control target is air conditioning, the measurement device 3 is provided with at least one sensor among a temperature sensor, a humidity sensor, a carbon dioxide sensor, and the like, for example. In a system whose control target is an indoor environment not in a living space but in a production line in an industrial plant, a gas sensor other than the above sensors may be provided to measure a concentration of gasses of various kinds. Besides, in a system whose control target is light modulation, the measurement device 3 is provided with an optical sensor (luminance sensor) and the like and measures a luminance in a measurement area. The measurement device 3 according to the embodiment is provided with a human figure detecting sensor for the purpose of adjusting the indoor environment depending on a person who stays in the target space. A sensing method of the human figure detecting sensor is not limited specifically, the method may be an infrared ray method, an ultrasonic method, a visible light method, and a combination of those methods may be used.

The control device 4 controls outputs of devices such as air conditioning equipment, light modulation equipment, daylighting equipment, and a speaker device provided in the indoor space as a control target. In other words, each of the devices, i.e., the air conditioning equipment, the light modulation equipment, the daylighting equipment, and the speaker device is provided with the control device 4 that adjusts an output of each device, and the management apparatus 21 controls those control devices 4 via the gateway 22. Here, the control device 4 and the control target may not be provided on a one-to-one basis. In other words, an indoor environment adjusting unit provided with at least two of the air conditioning function, the light modulation function, the speaker function, and the like may be used and one control device 4 may be configured to control multiple functions of the indoor environment adjusting unit, for example.

The host system 2 controls the indoor environment as a whole. While a configuration example in which the host system 2 is provided with the gateway 22 is explained here, the host system 2 may not necessarily be provided with the gateway 22. Specifically, a communication method at a side of the operation terminal 1 and the management apparatus 21 and a communication method at a side of the measurement device 3 and the control device 4 are different in the example in FIG. 1 and therefore both sides are configured to perform the data communication via the gateway 22. Conversely, when the communication method at the side of the operation terminal 1 and the management apparatus 21 and the communication method at the side of the measurement device 3 and the control device 4 are the same or have compatibility, the both sides are capable of data communication not via the gateway 22.

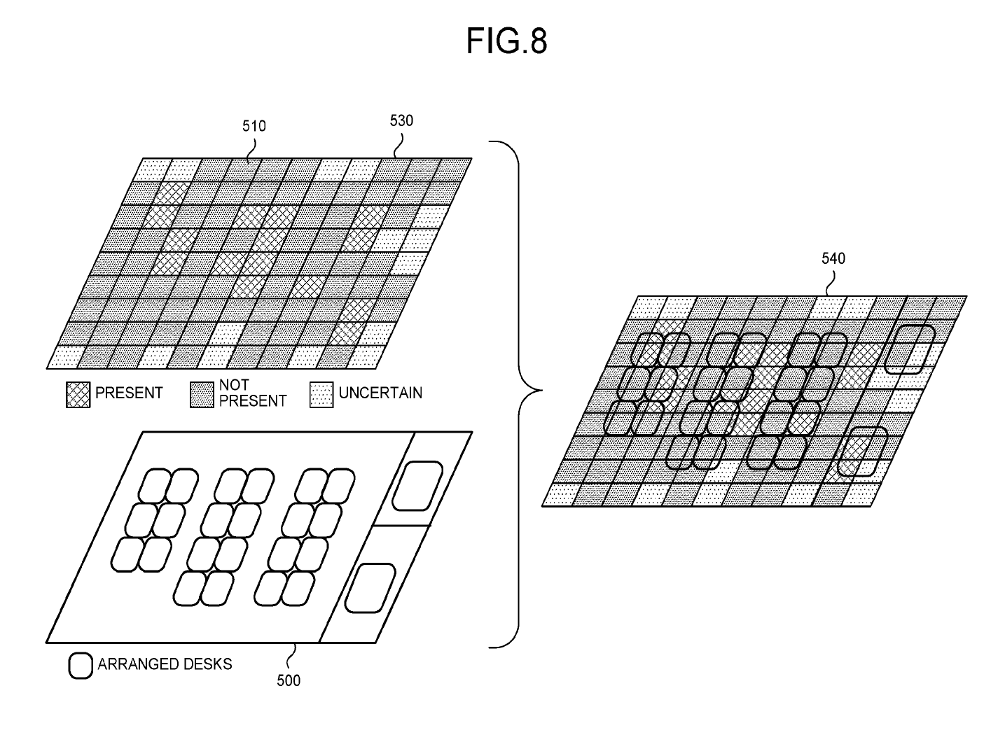

The management apparatus 21 receives data (measurement data) concerning the indoor environment measured by the measurement device 3 via the gateway 22. The management apparatus 21 generates display data for an indoor environment map based on the measurement data received from the measurement device 3 and a floor plan of an indoor space (indoor map) that own device manages. The indoor environment map indicates a distribution, superimposed and displayed on the floor map of the indoor space, of the measurement data of the indoor environment. A generation method of an indoor environment map 540 will be explained later with reference to FIG. 8. The management apparatus 21 transmits the generated display data for the indoor environment map to the operation terminal 1 to have the indoor environment map displayed on the display of the operation terminal 1.

Automatic Control of Indoor Environment

The management apparatus 21 performs an automatic adjustment control of the indoor environment based on the generated indoor environment map. Specifically, the management apparatus 21 generates control data for controlling each control device 4 based on the measurement data and conditions suitable for the indoor environment and transmits the control data to the control device 4 via the gateway 22 and the connection line 5. The control device 4 controls an output of each of the air conditioning equipment, the light modulation equipment, and the like based on the received control data.

Manual Control of Indoor Environment

The management apparatus 21 transmits the display data for the indoor environment map to the operation terminal 1 via the connection line 6 to have the indoor environment map displayed on the display of the operation terminal 1. A user of the operation terminal 1 is able to refer to the indoor environment map displayed on the display and to manually adjust the indoor environment. The management apparatus 21 generates control data for controlling the control device 4 based on the user operation received by the operation terminal 1 and transmits the control data to the control device 4 via the gateway 22 and the connection line 5. The control device 4 controls an output of each of the air conditioning equipment, the light modulation equipment, and the like based on the received control data.

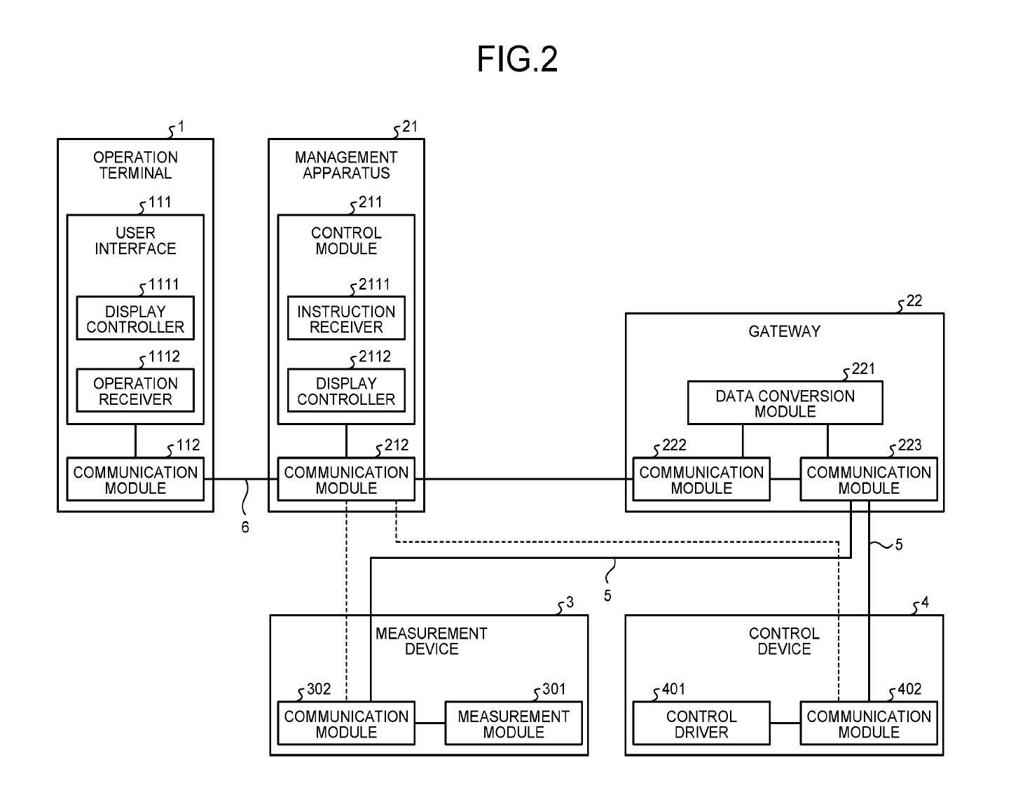

Next, a functional configuration of each of the devices of the indoor environment control system 1000 will be explained with reference to FIG. 2. FIG. 2 is a functional block diagram of a configuration of functions included in each of the devices in the indoor environment control system 1000.

First, a functional configuration of the operation terminal 1 will be explained. As illustrated in FIG. 2, the operation terminal 1 is provided with a user interface 111 and a communication module 112. The user interface 111 is provided with a display controller 1111 and an operation receiver 1112.

The display controller 1111 performs a processing of displaying various kinds of operation screens of the user interface 111 on the display of the operation terminal 1. The display controller 1111 also displays the indoor environment map on the operation screen based on the display data received from the management apparatus 21.

The operation receiver 1112 receives a user operation of selecting a control target area provided on the indoor environment map via the touch sensitive panel and the like. The operation receiver 1112 also receives a user operation of changing an output of the control device 4 associated with the selected control target area. Specifically, the operation receiver 1112 receives an instructing operation of changing outputs of air conditioning, luminance, volume, and the like depending on the kind of a control target. A reception method of instructing operations may be an input reception with respect to the operation screen, an operation reception with respect to the operation buttons and operation icons, a reception of audio input, and the like and is not limited specifically.

The operation receiver 1112 generates data including instruction content (instruction data). An example of the operation screen of the user interface 111 will be explained later.

The communication module 112 performs a processing of transmitting the instruction data generated by the user interface 111 to the management apparatus 21 via the connection line 6. The communication module 112 receives the display data for the indoor environment map from the management apparatus 21.

Next, a functional configuration of the management apparatus 21 will be explained. As illustrated in FIG. 2, the management apparatus 21 is provided with a control module 211 and a communication module 212. The control module 211 is provided with an instruction receiver 2111 and a display controller 2112.

When the communication module 212 receives instruction data from the operation terminal 1, the instruction receiver 2111 generates control data for controlling the control device 4 based on the instruction content included in the instruction data. For example, identification information of the control device 4 as a control target, an output value in changing the output, information indicating a speed in changing the output, and the like are included in the control data.

When the communication module 212 receives the measurement data from the measurement device 3, the display controller 2112 generates the display data for the indoor environment map based on the measurement data. The display controller 2112 transmits the generated display data for the indoor environment map to the operation terminal 1 by the communication module 212. The display controller 2112 thereby displays the indoor environment map on the operation screen of the operation terminal 1.

The communication module 212 performs a data communication processing among the management apparatus 21 and other devices as illustrated by solid line in FIG. 2. For example, the communication module 212 performs data communication of various kinds with the communication module 112 of the operation terminal 1. The communication module 212 performs data communication with the gateway 22. Through this, the communication module 212 performs the data communication between the management apparatus 21 and the measurement device 3 and the data communication between the management apparatus 21 and the control device 4 via the gateway 22 and the connection line 5.

Next, a functional configuration of the gateway 22 will be explained. The gateway 22 is provided with a data conversion module 221, a communication module 222, and a communication module 223.

The data conversion module 221 performs a data conversion when the communication method is different between the management apparatus 21 and the measurement device 3 or between the management apparatus 21 and the control device 4 and a direct communication therebetween is not available.

When the communication method is the same between the management apparatus 21 and the measurement device 3 or between the management apparatus 21 and the control device 4, data communication in a route illustrated by the dashed line in FIG. 2 is available. In other words, when the same communication method is used with each other, the communication module 212 of the management apparatus 21 performs a data communication with a communication module 302 of the measurement device 3 not via the gateway 22. Besides, when the same communication method is used with each other, the communication module 212 of the management apparatus 21 performs a data communication with a communication module 402 of the control device 4 not via the gateway 22.

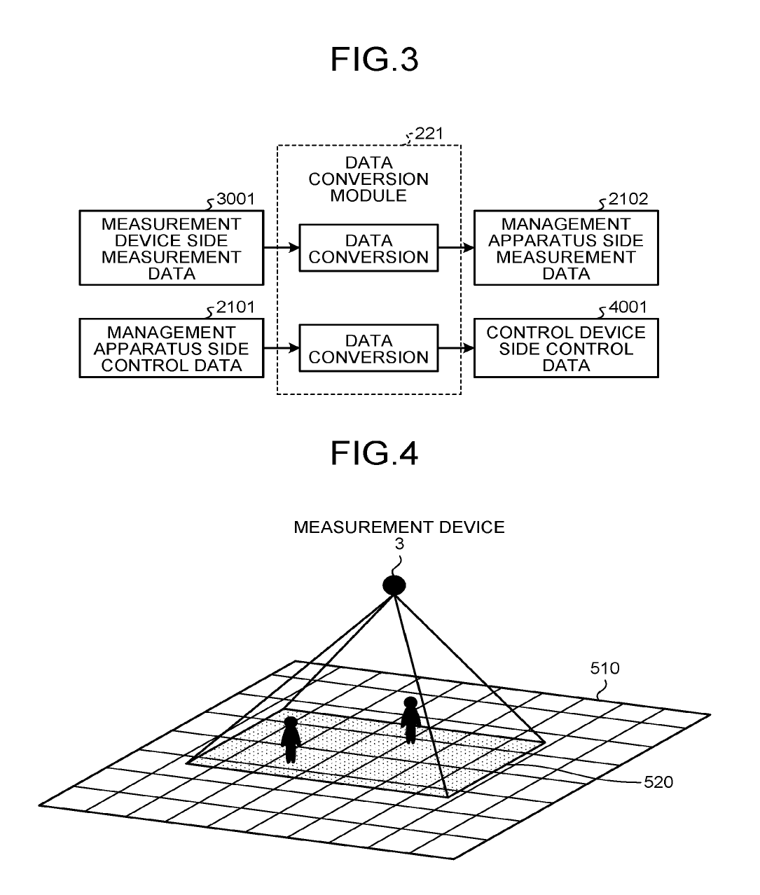

FIG. 3 is an explanatory view of a data conversion processing by the data conversion module 221. The data conversion module 221 performs a data conversion of the measurement data received from the measurement device 3 and the control data generated by the management apparatus 21, for example. In other words, when the communication module 223 of the gateway 22 receives measurement device side measurement data 3001, the data conversion module 221 performs a data conversion processing to generate measurement data of a format which is available at the side of the management apparatus 21 (management apparatus side measurement data 2102).

When the communication module 222 of the gateway 22 receives management apparatus side control data 2101, the data conversion module 221 performs a data conversion processing to generate control data of a format which is available at the side of the control device 4 (control device side control data 4001).

Referring back to FIG. 2, the communication modules 222 and 223 transmit data converted by the data conversion module 221 respectively to the side of the management apparatus 21 and the side of the control device 4. In other words, the communication module 222 transmits the management apparatus side measurement data 2102 (see FIG. 3) generated by the data conversion module 221 to the communication module 212 of the management apparatus 21. The communication module 223 transmits the control device side control data 4001 (see FIG. 3) generated by the data conversion module 221 to the communication module 402 of the control device 4.

Next, a functional configuration of the measurement device 3 will be explained. As illustrated in FIG. 2, the measurement device 3 is provided with a measurement module 301 and the communication module 302.

The measurement module 301 reads output values from various kinds of sensors provided in the measurement device 3, and generates and manages measurement data concerning the indoor environment.

FIG. 4 is a perspective view explaining an installation example of the measurement device 3 and the measurement area thereof. In FIG. 4, an example of installing the measurement device 3 on a ceiling of an indoor area 510 is illustrated. The measurement module 301 (see FIG. 2) of the measurement device 3 measures the indoor environment in a measurement area 520. As illustrated in FIG. 4, when the indoor area 510 is divided into zones each having a predetermined area, the measurement device 3 is capable of obtaining measurement data by treating a plurality of zones thereamong as the measurement area 520. Here, the measurement area 520 may step over a border of zones. In a configuration in which the measurement module 301 is provided with a plurality of sensors, respective measurement areas may be present depending on respective sensing ranges.

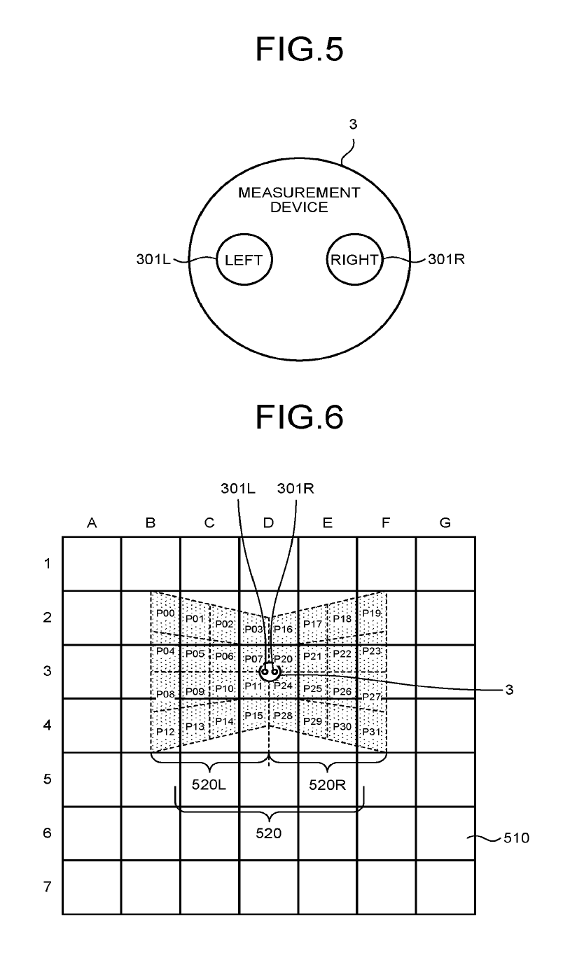

FIG. 5 is a front view when the measurement device 3 installed on the ceiling is seen from a position right under the device. A case where the measurement device 3 is provided with a human figure detecting sensor will be explained below as one example. As illustrated in FIG. 5, a measurement module 301L is provided at a left side in the measurement device 3 installed on the ceiling when the measurement device 3 is seen from the position right under the device. A measurement module 301R is provided at a right side in the measurement device 3 when the measurement device 3 is seen from the position right under the device. Next, a correspondence between the measurement area 520 of each measurement module 301 and the indoor area 510 will be explained.

FIG. 6 illustrates a frame format of an example of a correspondence between the measurement area 520 of the measurement device 3 and the indoor area 510 which is divided into zones. As illustrated in FIG. 6, the measurement area 520 of the measurement device 3 corresponds to a sum of a measurement area 520L of the measurement module 301L and a measurement area 520R of the measurement module 301R. The measurement modules 301L and 301R divide the measurement areas 520L and 520R respectively into sixteen compartments to detect a figure in each compartment. In other words, the measurement module 301L detects, with respect to detection compartments P00 to P15 which are the result of the division of the measurement area 520L into sixteen compartments, a figure present within any of the detection compartments. The measurement module 301R detects, with respect to detection compartments P16 to P31 which are the result of the division of the measurement area 520R into sixteen compartments, a figure present within any of the detection compartments.

As illustrated in FIG. 6, when the measurement device 3 is arranged at a center position of a zone D3 of the indoor area 510, the detection compartments P00 to P15 of the measurement area 520L are configured to be present over zones B2 to D2, B3 to D3, and B4 to D4 of the indoor area 510. Besides, the detection compartments P16 to P31 of the measurement area 520R are configured to be present over zones D2 to F2, D3 to F3, and D4 to F4 of the indoor area 510.

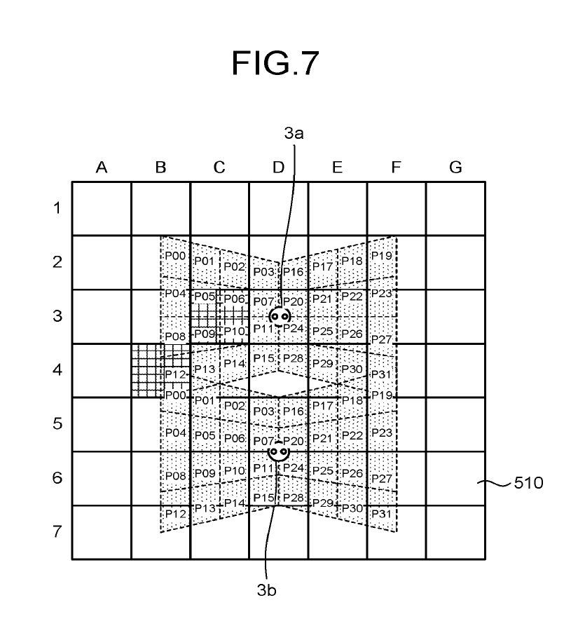

Next, a method of generating the measurement data 3001 (see FIG. 3) at the side of the measurement device 3 will be explained with reference to FIG. 7. FIG. 7 illustrates a frame format explaining the method of generating the measurement data 3001 (see FIG. 3) by the measurement device 3.

The measurement module 301 (see FIG. 2) of the measurement device 3 determines whether or not to have detected a figure in any zone of the indoor area 510 based on a correspondence relation between the zones A1 to G7 of the indoor area 510 and the detection compartments P00 to P31 of the measurement device 3.

In other words, as illustrated in FIG. 7, when a measurement device 3a is arranged at a center position of the zone D3 of the indoor area 510, the detection compartments P00 to P31 of the measurement device 3a are configured to be present over the zones B2 to F4 of the indoor area 510. In the embodiment, the detection compartments P00 to P31 of the measurement device 3a are associated with the zones of the indoor area 510 in advance based on information including an installation angle (field angle) of the measurement device 3a, a height from the floor (distance from the ceiling), a detectable height, and the like.

In FIG. 7 for example, the zone C3 of the indoor area 510 includes center coordinates of the detection compartments P05, P06, P09, and P10 of the measurement device 3a. Therefore, the measurement module 301 of the measurement device 3a determines that a figure is detected in the zone C3 in the indoor area 510 when the human figure detecting sensor indicates a detection reaction with respect to the detection compartments P05, P06, P09, and P10.

As another example, the zone B4 of the indoor area 510 in FIG. 7 includes center coordinates of the detection compartment P12 of the measurement device 3a and center coordinates of the detection compartment P00 of a measurement device 3b. When the human figure detecting sensor indicates the detection reaction with respect to the detection compartment P12, the measurement module 301 of the measurement device 3a determines that a figure is detected in the zone B4 in the indoor area 510. When the human figure detecting sensor indicates the detection reaction with respect to the detection compartment P00, the measurement module 301 of the measurement device 3b determines that a figure is detected in the zone B4 in the indoor area 510.

The measurement module 301 (see FIG. 2) then generates the measurement data 3001 by associating each zone, associated with the measurement device 3, of the indoor area 510 with presence/absence of a detection of a figure in the zone. For example, the measurement module 301 generates, as the measurement data 3001, a series of data including “the zone B2: not detected, the zone C2: not detected, the zone D2: not detected . . . , the zone C3: detected . . . , and the zone F4: not detected”.

The size of each zone is configured to be set by the user arbitrarily. Zones may be set finely, may be associated with the detection compartments on a one-to-one basis, and then a finer determination may be made with respect to the detection result. Or, zones may be set widely and a detection result may be averaged to reduce a communication data amount.

Referring back to FIG. 2, the communication module 302 transmits the measurement data 3001 generated by the measurement module 301 to the gateway 22.

Next, a functional configuration of the control device 4 will be explained. As illustrated in FIG. 2, the control device 4 is provided with a control driver 401 and the communication module 402.

The communication module 402 receives the control device side control data 4001 (see FIG. 3) output by the gateway 22.

The control driver 401 controls the output of the control target device such as the air conditioning equipment, the light modulation equipment, the daylighting equipment, and the speaker device based on the control data 4001 received by the communication module 402.

Next, a method of generating display data for the indoor environment map by the display controller 2112 of the management apparatus 21 will be explained.

FIG. 8 is an explanatory view of a method of generating the display data. The display controller 2112 (see FIG. 2) generates a detection result map 530 in which a figure detection result in each zone of the indoor area 510 is reflected based on the measurement data 3001 (see FIG. 3) received from a plurality of measurement devices 3 via the gateway 22.

For example, when receiving, from any one of the measurement devices 3 associated with a given zone, a result to the effect that a figure is detected in the zone, the display controller 2112 determines “figure is detected (present)” for the zone. When receiving, from all the measurement devices 3 associated with the zone, a result to the effect that a figure is not detected in the zone, the display controller 2112 determines “figure is not detected (not present)” for the zone. When the number of the measurement devices 3 that transmit the result to the effect that a figure is detected in the zone is comparable with the number of the measurement devices 3 that transmit the result to the effect that a figure is not detected, the display controller 2112 determines “uncertain about figure detection (uncertain)” for the zone. When there is a zone not belonging to a detection compartment of any of the measurement devices 3, a result for the zone is configured to be “uncertain about figure detection (uncertain)”.

In this manner, when a plurality of measurement devices 3 (or a plurality of measurement spots) are provided in the zones of the indoor area 510, the display controller 2112 determines an ultimate measurement result depending on a logical addition of the measurement results in the zones.

The display controller 2112 then generates the detection result map 530 in which respective zones are color-coded depending on respective determination results. Here, the detection results may be displayed by, other than color coding, changing a display pattern or changing a display density in the detection result map 530.

Next, the display controller 2112 makes the generated detection result map 530 and an indoor floor plan 500 superimposed to generate display data for the indoor environment map 540. Here, as exemplified in FIG. 8, desks and partitions already arranged, walls, and the like are drawn in the indoor floor plan 500. It is possible to edit the indoor floor plan 500 from the management apparatus 21 or the operation terminal 1.

The communication module 212 (see FIG. 2) of the management apparatus 21 transmits the display data for the indoor environment map 540 generated by the display controller 2112 to the operation terminal 1 via the connection line 6. When the communication module 112 of the operation terminal 1 receives the display data, the display controller 1111 of the operation terminal 1 displays the indoor environment map 540 on the operation screen. Since the indoor environment map 540 is displayed in the operation terminal in this manner, it is possible for the user of the operation terminal 1 to easily check what the conditions of the indoor environment are like by the operation terminal 1 at hand without leaving the place and waking around the indoor space.

Next, an example in which the measurement device 3 is provided with a human figure detecting sensor and a luminance sensor and a result of the human figure detection and a result of the luminance measurement are superimposed in the indoor environment map will be explained.

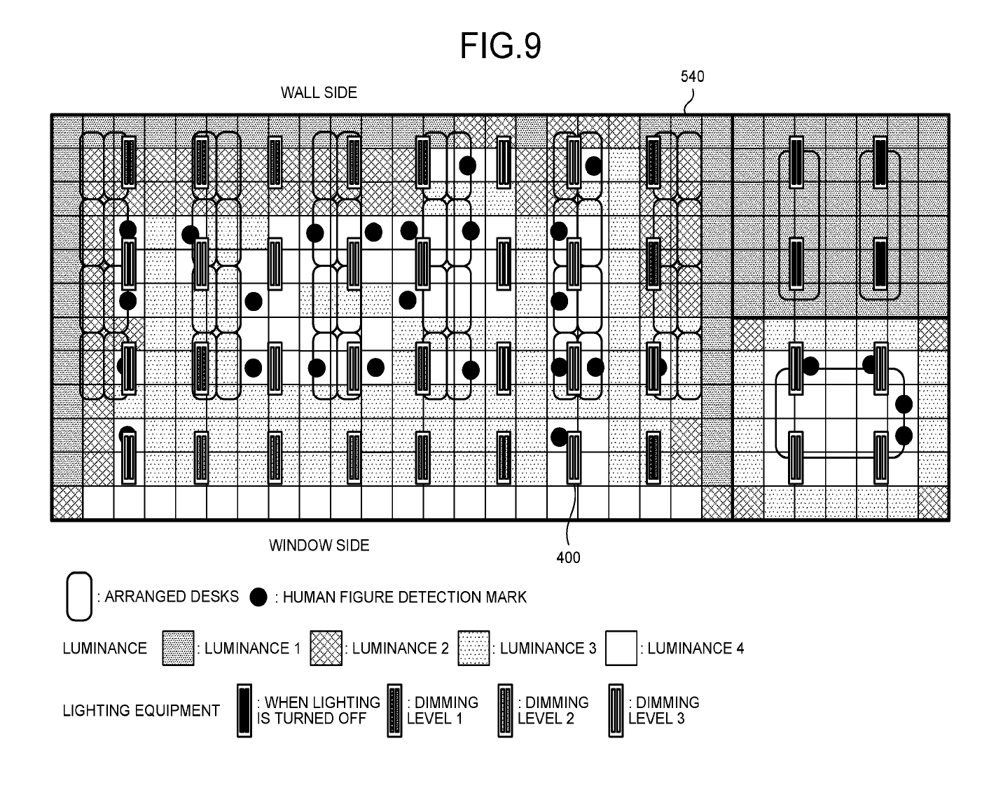

FIG. 9 illustrates the indoor environment map 540 displayed in the operation terminal 1. In the example in FIG. 9, the result of the human figure detection by the human figure detecting sensor is indicated by a filled circle and the result of the luminance measurement by the luminance sensor is indicated by a color density depending on the luminance in the indoor environment map 540.

In the indoor environment map 540, an illustration of lighting equipment 400 is displayed, as one example of the control target device of the control device 4, depending on the installation position in the indoor space in the indoor environment map 540. The illustration of each of the lighting equipment 400 is displayed by using color density depending on the control status, i.e., the dimming level.

In this manner, the result of the human figure detection, the result of the luminance measurement, the control status (dimming level) of the lighting equipment are superimposed and displayed on the indoor floor plan in the example in FIG. 9. This configuration allows the user to get a quick overview of the control status (output status) of the indoor environment and the actual condition of the indoor environment in one glance. It is therefore possible for the user to check, in one glance, the location where the dimming level is larger than enough in luminance in spite of no human presence. In other words, it is possible for the user to check the location where the lighting can be turned off by the operation terminal 1 at hand without actually waking around the indoor space and to easily save the power consumption.

Here, a method of automatically controlling the lighting equipment 400 will be explained. While a manual control of the output of the lighting equipment 400 is available through the operation in the operation terminal 1, an automatic control by the management apparatus 21 is also performed together.

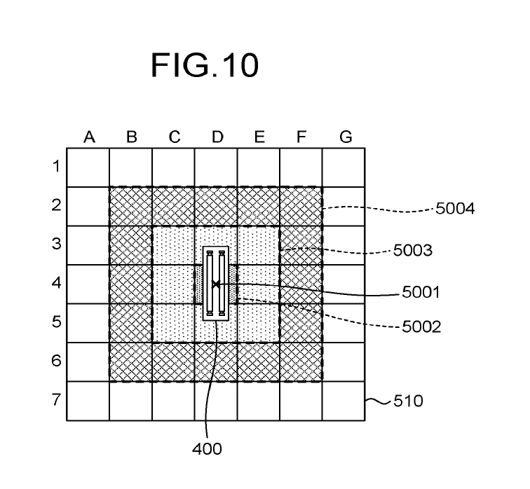

FIG. 10 is an explanatory view of an example of the method of automatically controlling the lighting equipment 400. Here, a case where the measurement device 3 transmits the detection result by the human figure detecting sensor to the management apparatus 21, the management apparatus 21 automatically controls the output of the lighting equipment 400 as the control device 4 based on the result of the human figure detection will be taken as an example and explained. Here, the control method is not limited thereto and the management apparatus 21 may adjust the output of the lighting equipment 400 by taking other measurement results including the luminance into consideration.

As illustrated in FIG. 10, center coordinates 5001 of the lighting equipment 400 locate in the zone D4 in the indoor area 510 which is divided into zones. In other words, an area 5002 including the center coordinates 5001 of the lighting equipment 400 corresponds to the zone D4 of the indoor area 510.

An area including the area 5002 and an area of outer circumferential zones for circumferential one layer around the area 5002 is treated as an area 5003. In other words, the area 5003 includes nine zones for C3 to E3, C4 to E4, and C5 to E5.

An area including the area 5002 and an area of outer circumferential zones for circumferential two layers around the area 5002 is treated as an area 5004. In other words, the area 5004 includes twenty five zones for B2 to F2, B3 to F3, B4 to F4, B5 to F5, and B6 to F6.

The control module 211 (see FIG. 2) of the management apparatus 21 maintains the current output value as it is for the output of the lighting equipment 400 when a figure is detected in the inner area 5003 surrounding the lighting equipment 400. In other words, the current dimming level is maintained as it is for the dimming level of the lighting equipment 400. This is because a configuration in which a person present in the space intentionally sets the current dimming level through an indoor switch or the operation terminal 1 is assumed here. To realize a configuration in which more emphasis is placed on the automatic adjustment, the dimming level may be set to a predetermined value (maximum value, for example) when a figure is kept on detecting for a predetermined period of time in the area 5003. This configuration allows an automatic detection of a human figure and also an automatic lighting of the lighting equipment 400.

When not detecting a figure in the inner area 5003 while detecting a figure in the area 5004 which is a wider range surrounding the lighting equipment 400, the control module 211 reduces the output of the lighting equipment 400. In other words, the light of the lighting equipment 400 is dimmed in modulation.

When not detecting a figure in both of the areas 5003 and 5004, the control module 211 turns off the output of the lighting equipment 400. In other words, the light of the lighting equipment 400 is turned off.

More specifically, the control module 211 associates an identifier of each of the lighting equipment 400 in the indoor space with the dimming level which is to be instructed to the corresponding lighting equipment 400 to generate control data. The communication module 212 of the management apparatus 21 transmits the control data to the control device 4 via the gateway 22. In other words, among the control devices 4 that control the plurality of lighting equipment 400 provided in the indoor space, the communication module 212 transmits, to the control device 4 as the control target, the control data indicating control content thereof.

The control device 4 adjusts the dimming level of each of the lighting equipment 400 based on the control data transmitted from the management apparatus 21. The management apparatus 21 performs an automatic control of the light modulation of the lighting equipment 400 in conjunction with the human figure detecting sensor in this manner. With this configuration, it is possible for the management apparatus 21 to dim or turn off the lighting equipment 400 which locates far away from the person in the space while keeping the lighting equipment 400 locating close to the person in the space bright, and save the power consumption.

Next, a method of setting the control target area in the indoor environment from the operation terminal 1 will be explained. In adjusting the dimming level and air conditioning, each control device 4 (lighting equipment 400, for example) may be treated as a control target and an output of each control device 4 may be controlled. On the other hand, it is possible when a plurality of control devices 4 in the indoor space are treated collectively as the control target to adjust the indoor environment of wider range at once and thereby improve operability and convenience.

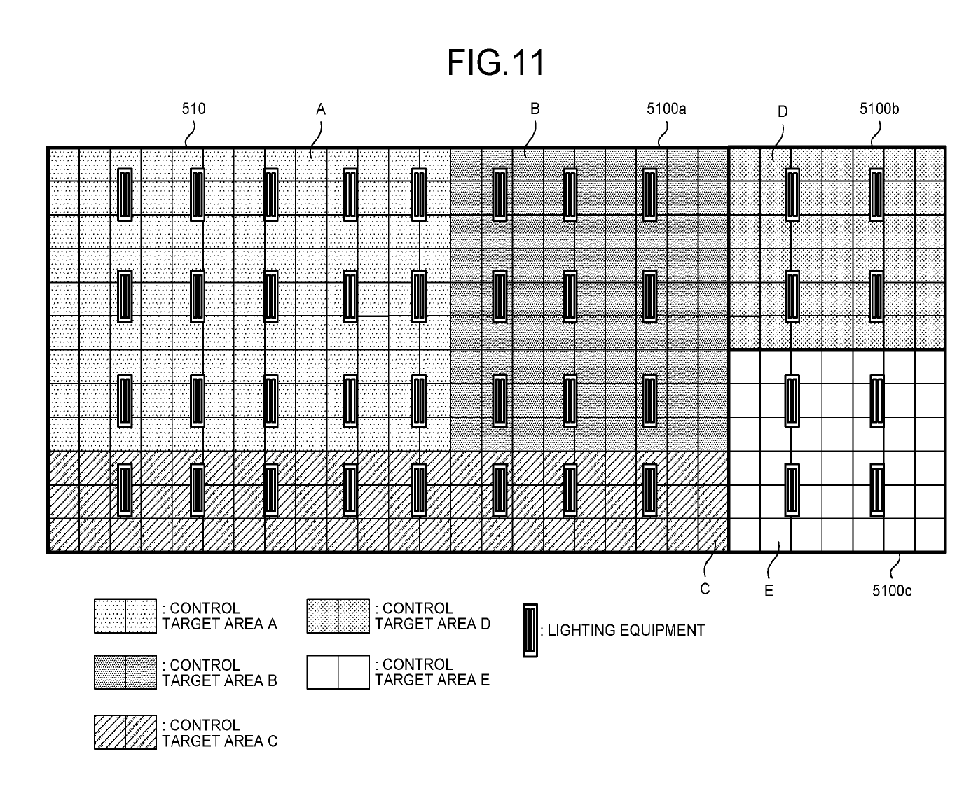

FIG. 11 is an explanatory view of an example of a setting of a control target area. In FIG. 11, the indoor area 510 is divided into three small rooms and an example of an indoor layout in which the indoor area 510 includes small areas 5100a, 5100b, and 5100c is illustrated.

A user is able to set and change the small areas 5100a to 5100c via the user interface 111 of the operation terminal 1. In other words, the user is able to edit the indoor layout. The user is also able to set the control target area by which a plurality of control devices 4 are collectively controlled via the user interface 111. The control target area indicates an area which is set to collectively control the control targets (or control devices 4) arranged in each control target area.

In FIG. 11, three control target areas A, B, and C are provided to the small area 5100a, one control target area D is provided to the small area 5100b, and one control target area E is provided to the small area 5100c. In this manner, one or more than one control target area may be provided to one small area (or one indoor area).

The management apparatus 21 performs the manual control via the operation terminal 1 for each control target area when the control target areas A to E are set as explained above. Here, the management apparatus 21 may perform the automatic control of the indoor environment, too for each control target area.

Next, a control method in a manual control of each control target area form the operation terminal 1 will be explained.

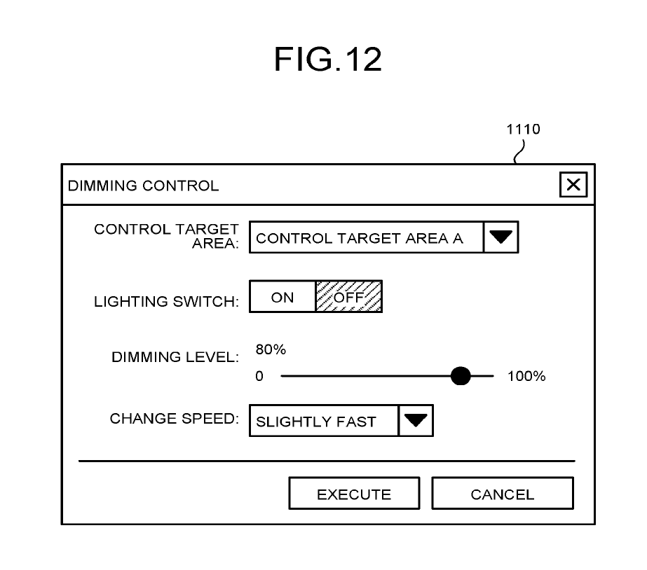

FIG. 12 illustrates an example of a dimming control screen 1110 which is displayed in the operation terminal 1. The operation terminal 1 transmits a request for transmitting display data to the management apparatus 21 depending on a user operation and the management apparatus 21 responds, to the operation terminal 1, with transmission of the display data depending on the request. Based on the display data, the user interface 111 of the operation terminal 1 displays the dimming control screen 1110 as illustrated in FIG. 12 on the display.

As illustrated in FIG. 12, a pull-down menu that allows selecting a control target area is provided in the dimming control screen 1110. The user selects one of the control target areas (control target areas A to E) set in the management apparatus 21 from the pull-down menu. In the dimming control screen 1110, a selection menu that allows selecting ON/OFF of the lighting and a slide bar that allows adjusting the dimming level of the lighting are provided to the selected control target area. In addition, a selection menu that allows selecting a speed of change of the light modulation in stages when the setting in the dimming control screen 1110 is executed is provided in the dimming control screen 1110.

When an execution icon is selected in the dimming control screen 1110, the user interface 111 of the operation terminal 1 associates the selected control target area with information set for each of other items to generate instruction data. The user interface 111 then transmits the generated instruction data to the management apparatus 21. The control module 211 of the management apparatus 21 generates control data that causes the control device 4 included in the instructed control target area to perform an output appropriate to the instruction content based on the received instruction data. The management apparatus 21 then transmits the generated control data to each control device 4 included in the control target area via the gateway 22. The control device 4 having received the control data changes the output based on the received control data to adjust the indoor environment.

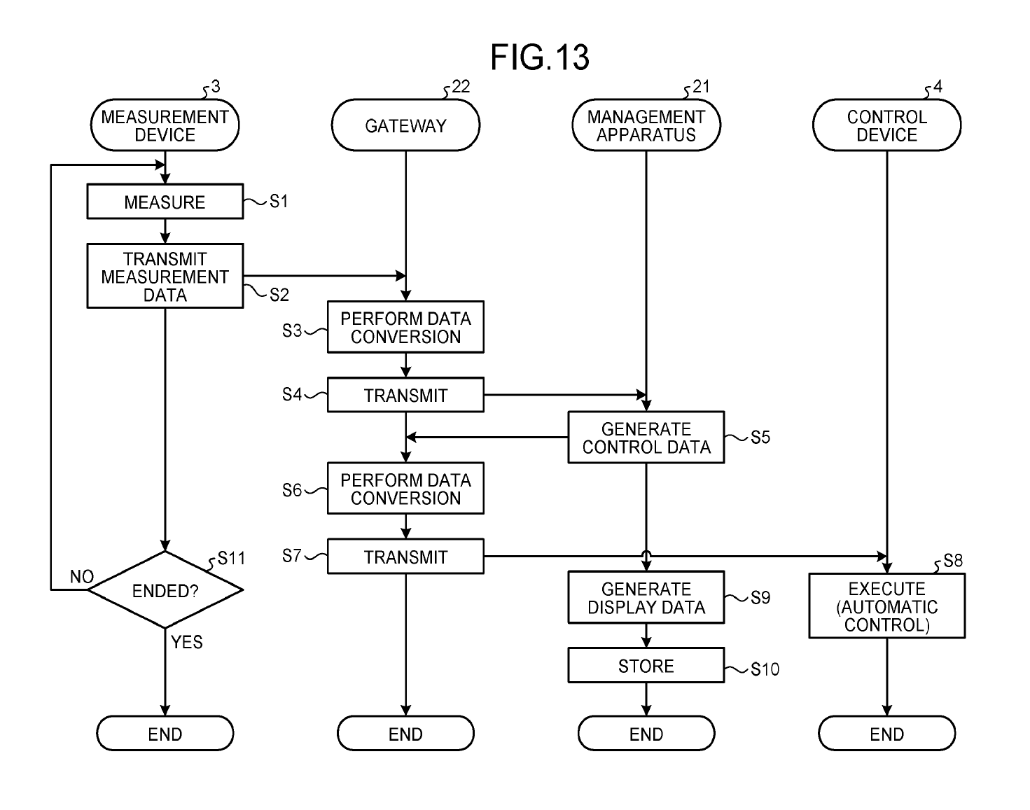

FIG. 13 is a sequence diagram illustrating an example of a procedure of a display data generation processing for measurement result, the processing being executed in the indoor environment control system 1000.

The measurement device 3 starts a measurement of the indoor environment by a sensor provided in own device when the power is supplied (step S1). The measurement device 3 then uses an output value of the sensor to generate the measurement data of the indoor environment and transmits the measurement data to the gateway 22 (step S2). After that, the measurement device 3 goes back to step S1 to continue the measurement processing while the power supply is not ended (“No” at step S11). On the other hand, when the power supply is ended (“Yes” at step S11), the measurement device 3 ends the measurement processing.

When receiving the measurement data from the measurement device 3, the gateway 22 converts a data format of the measurement data (step S3). In other words, the gateway 22 converts the data format of the measurement data from a data format when generated in the measurement device 3 to a data format available in the management apparatus 21. The gateway 22 then transmits the converted measurement data to the management apparatus 21 (step S4).

The management apparatus 21 generates the control data by which an output change of the control device 4 is instructed based on the received measurement data (step S5). The control data generated here is what is used when the management apparatus 21 performs the automatic control of the output of the control device 4 based on the measurement data. In other words, the control data here is what is used when the indoor environment is automatically controlled.

The management apparatus 21 transmits the generated control data to the gateway 22. The gateway 22 converts the data format of the received control data from the data format at the side of the management apparatus 21 to the data format which is available at the side of the control device 4 (step S6). The gateway 22 then transmits the converted control data to the control device 4 that is specified as the control target in the control data (step S7).

The control device 4 having received the control data executes the received control data for automatic control, changes the output of the control target device, and adjusts the indoor environment (step S8).

The management apparatus 21 generates the display data for the indoor environment map based on the measurement data received at step S4 (step S9) and stores the generated display data for the indoor environment map in a storage unit of oneself (step S10).

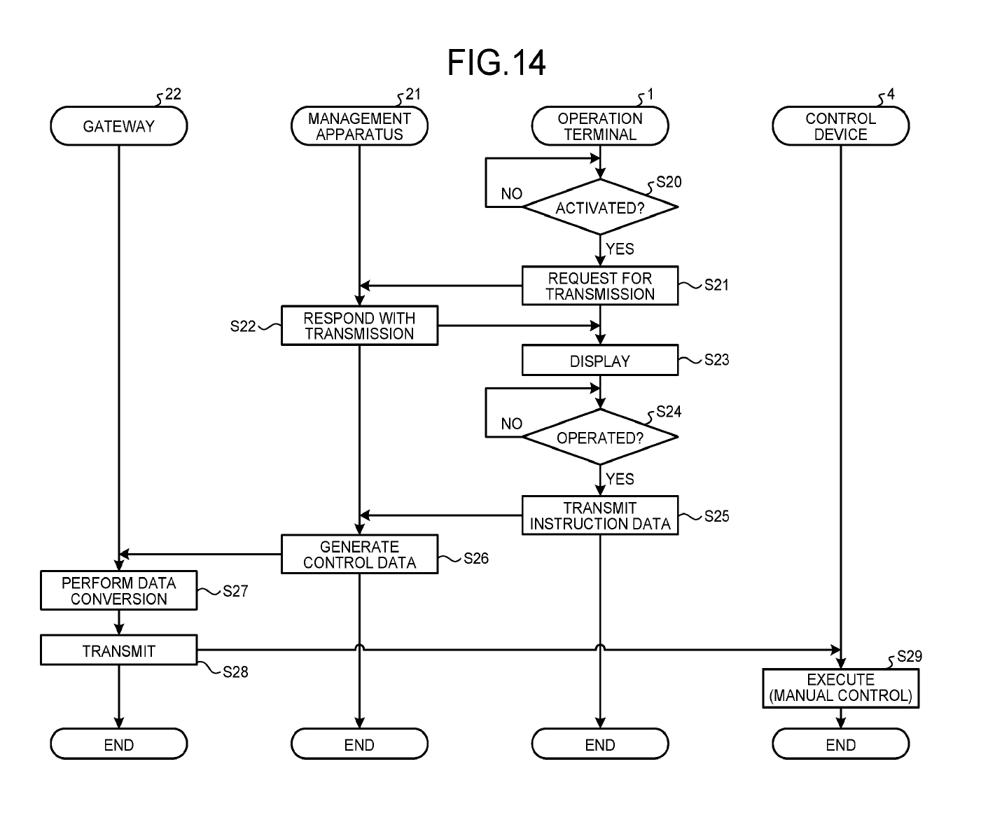

FIG. 14 is a sequence diagram illustrating an example of a procedure of the manual control processing executed in the indoor environment control system 1000.

When receiving an operation with respect to the user interface 111 and receiving an operation of activating an indoor environment control application and the like (“Yes” at step S20), the operation terminal 1 outputs the request for transmitting the display data for the indoor environment map to the management apparatus 21 (step S21). On the other hand, when not receiving the activation operation and the like (“No” at step S20), the operation terminal 1 stands ready without change.

When receiving the request for transmitting the display data, the management apparatus 21 reads the display data for the indoor environment map stored in the storage unit at step S10 in FIG. 13 and responds with transmission to the operation terminal 1 (step S22). When receiving the display data, the operation terminal 1 uses the received display data to display the indoor environment map on the display (step S23). When the user interface 111 of the operation terminal 1 receives an operation concerning the manual control of the indoor environment (“Yes” at step S24), the operation terminal 1 generates instruction data depending on the operation and transmits the instruction data to the management apparatus 21 (step S25). On the other hand, when the user interface 111 does not receive the operation (“No” at step S24), the operation terminal 1 stands ready without change.

The management apparatus 21 generates control data of instructing a change of the output of the control device 4 based on the received instruction data (step S26). The control data generated here is what is used when the management apparatus 21 controls the output of the control device 4 based on the instruction from the user. In other words, the control data is what is used when the indoor environment is manually controlled.

The management apparatus 21 transmits the generated control data to the gateway 22. The gateway 22 converts the data format of the received control data from the data format at the side of the management apparatus 21 to the data format available at the side of the control device 4 (step S27). The gateway 22 then transmits the converted control data to the control device 4 specified as the control target in the control data (step S28).

The control device 4 having received the control data executes the received control data for manual control, changes the output of the control target device, and adjusts the indoor environment (step S29).

Programs to be executed in the operation terminal 1 according to the embodiment are provided by being preloaded in a ROM and the like. The programs to be executed in the operation terminal 1 according to the embodiment may be recorded in a file of an installable format or of an executable format in a computer-readable recording medium such as a CD-ROM, a flexible disk (FD), a CD-R, and a DVD (Digital Versatile Disk) as a computer program product.

The programs to be executed in the operation terminal 1 according to the embodiment may be stored on a computer connected to a network such as the Internet and provided by being downloaded via the network. The programs to be executed in the operation terminal 1 according to the embodiment may be provided or distributed via a network such as the Internet.

The programs to be executed in the operation terminal 1 according to the embodiment have a module configuration including the units explained above (the display controller 1111 and the operation receiver 1112) and, as an actual hardware, the units are configured to be loaded on a main storage device to generate on the main storage unit the display controller 1111 and the operation receiver 1112 when the CPU (processor) reads out from the ROM and executes the programs.

The management apparatus 21 according to the embodiment, which is provided with a control device such as a CPU, a storage device such as a ROM (Read Only Memory) and a RAM, an external storage device such as an HDD and a CD drive device, a display device such as a display, and an input device such as a keyset and a mouse, has a hardware configuration using a normal computer.

Programs to be executed in the management apparatus 21 according to the embodiment may be provided by being recorded in a file of an installable format or of an executable format in a computer-readable recording medium such as a CD-ROM, a flexible disk (FD), a CD-R, and a DVD (Digital Versatile Disk) as a computer program product.

The programs to be executed in the management apparatus 21 according to the embodiment may be stored on a computer connected to a network such as the Internet and provided by being downloaded via the network. The programs to be executed in the management apparatus 21 according to the embodiment may be provided or distributed via a network such as the Internet. The programs to be executed in the management apparatus 21 according to the embodiment may be provided by being preloaded in a ROM and the like.

The programs to be executed in the management apparatus 21 have a module configuration including the units explained above (the instruction receiver 2111 and the display controller 2112) and, as an actual hardware, the units are configured to be loaded on a main storage device to generate on the main storage unit the instruction receiver 2111 and the display controller 2112 when the CPU reads out from a storage medium and executes the programs.

As explained so far, an indoor environment map in which a distribution of measurement data of an indoor environment is superimposed on an indoor floor plan is displayed on the operation terminal 1 according to the embodiment. Therefore, it is possible for the user of the operation terminal 1 according to the embodiment to check the condition of the indoor environment easily. In other words, it is possible for the user of the operation terminal 1 to check information that the user wants to check in manually adjusting the indoor environment in one glance. Since the user is able to estimate the state of other persons in the space to some degree, it becomes easy for the user of the operation terminal 1 to adjust the indoor temperature and turn on/off the lighting casually. As seen above according to the embodiment, it is possible for the user to improve the convenience in manually adjusting the indoor environment.

According to the embodiment, there is an advantage in that a display of a measurement result on a floor plan of an indoor space in an operation terminal of a user enables easily checking indoor conditions in a manual adjustment of an indoor environment.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An indoor environment management apparatus comprising:
a receiver configured to receive a measurement result from a measurement device that measures data concerning an indoor environment;
a display controller configured to display, in an operation terminal of a user, an indoor environment map in which the measurement result received by the receiver is displayed on a floor plan of an indoor space;
an operation receiver configured to receive a user operation with respect to a control device that adjusts the indoor environment from the operation terminal; and
a control unit configured to generate control information by which the indoor environment is changed depending on the user operation, and output the generated control information to the control device.

2. The indoor environment management apparatus according to claim 1, wherein
a plurality of luminance sensors and a plurality of human figure detecting sensors are each arranged as the measurement device in the indoor space,
the receiver receives measurement results for respective measurement spots from the plurality of luminance sensors and the plurality of human figure detecting sensors, and
the display controller superimposes and displays, on the floor plan of the indoor space, a luminance and a result of a human figure detection for each measurement spot.

3. The indoor environment management apparatus according to claim 1, wherein the display controller divides the floor plan of the indoor space into a plurality of zones, and displays the measurement result for each of the zones by color coding depending on the measurement result.

4. The indoor environment management apparatus according to claim 3, wherein when a plurality of measurement devices are provided in one of the zones, the display controller displays the one zone with a color depending on a logical addition of measurement results in the zone.

5. The indoor environment management apparatus according to claim 1, further comprising: a control area divider configured to divide the indoor space into a plurality of control target areas, wherein
the control unit collectively controls a plurality of control devices arranged in the control target areas.

6. The indoor environment management apparatus according to claim 5, wherein
the operation receiver receives an operation of selecting a control target area to be controlled from the control target areas, and receives a user operation for indoor environment adjustment with respect to the selected control target area, and
the control unit generates the control information about the control device belonging to the control target area and outputs the generated control information to the control device belonging to the control target area.

7. An indoor environment control system comprising:
a measurement device configured to measure data concerning an indoor environment;
a control device configured to adjust the indoor environment;
an operation terminal configured to receive a user operation with respect to the control device; and
an indoor environment management apparatus connected to the measurement device, the control device, and the operation terminal,
the indoor environment management apparatus including
a receiver configured to receive a measurement result from the measurement device;
a display controller configured to display, in the operation terminal, an indoor environment map in which the measurement result received by the receiver is displayed on a floor plan of an indoor space;
an operation receiver configured to receive a user operation with respect to the control device from the operation terminal; and
a control unit configured to generate control information by which the indoor environment is changed depending on the user operation, and output the generated control information to the control device.

8. The indoor environment control system according to claim 7, further comprising a gateway configured to interface data communication between the indoor environment management apparatus and the measurement device, and interface data communication between the indoor environment management apparatus and the control device.

9. A non-transitory recording medium with an executable program stored thereon, wherein the program instructs a computer to perform:
receiving a measurement result from a measurement device that measures data concerning an indoor environment;
displaying, in an operation terminal of a user, an indoor environment map in which the received measurement result is displayed on a floor plan of an indoor space;
receiving a user operation with respect to a control device that adjusts the indoor environment from the operation terminal;
generating control information by which the indoor environment is changed depending on the user operation; and
outputting the generated control information to the control device.
